(19) United States
(12) Patent Application Publication
(10) Pub. No.: US 2007/0200695 A1
(43) Pub. Date: Aug. 30, 2007

(54) System and method for monitoring location of object such as child

(76) Inventors: Cristian Almstrand, San Diego, CA (US); Jason Lee Clement, San Diego, CA (US)

Correspondence Address: ROGITZ & ASSOCIATES, 750 B STREET, SUITE 3120, SAN DIEGO, CA, 92101, US

(21) Appl. No.: 11/365,741

(22) Filed: Feb. 28, 2006

(51) Int. Cl. G08B 1/08

(52) U.S. Cl. 340/539.13

(57) ABSTRACT

A child's wireless telephone periodically transmits its GPS position to a Web server that a parent can access. The child's position can be plotted on a map so the parent can view where the child is. The map can show approved areas and/or excluded areas, and an automatic alert can be sent to the parent using, e.g., SMS in the event that the child strays out of the approved areas.

### I. FIELD OF THE INVENTION

The present invention relates generally to methods and systems for monitoring mobile objects such as children.

### II. BACKGROUND OF THE INVENTION

It is often the case that parents wish to know the whereabouts of their children unobtrusively. For instance, in particular for small children parents who might be at work or otherwise distanced from their children might wish to know that the child is located in an expected place, e.g., in a school or at a friend's house, without alienating the child by calling teachers, friends, etc. to check up. Furthermore, the present invention understands that in the event that a child departs from approved areas as happens during kidnappings, it would be highly advantageous to automatically send an alert to parents or law enforcement. With these recognitions in mind, the invention herein is provided.

### SUMMARY OF THE INVENTION

A system includes a mobile communication device such as a wireless telephone that is configured to receive position information such as global positioning satellite (GPS) information representative of the location of the device. The device is configured to communicate the position information to a wireless telephony system. A monitoring computer receives the position information and displays the position information on a display.

A monitoring server may be provided to receive the information from the wireless telephony system and to communicate the information over the Internet to the monitoring computer. A data store may also be provided that contains electronic map information. The monitoring computer receives map information from the data store and presents on the display a map in accordance with the map information, with the location of the mobile communication device indicated on the map. The data store can contain approved areas and/or excluded areas, and the monitoring computer can be configured to receive an alert when the GPS information indicates that the location of the mobile communication device is outside the approved areas or inside the excluded areas. Or, the position information may be presented to the monitoring computer in a non-map format, e.g., by alpha-numeric street address or by alpha-numeric latitude and longitude display. Both the position information from the mobile communication device and the alert may be sent using short message service (SMS).

In another aspect, a computer medium such as a data store or data storage device stores a program of instructions executable by a computer processor to receive a GPS location of a designated wireless communication device. The wireless communication device is associated with a monitored object. The GPS location is plotted on a map.

In still another aspect, a method is disclosed for monitoring the location of a person. The method includes, at a wireless telephone carried by the person, receiving position information from a satellite, and sending the information from the wireless telephone to a Web server. The method also includes allowing a monitor to access the Web server over the Internet using a monitoring computer. A display showing the location of the person as represented by the information is presented on the monitoring computer.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram showing a non-limiting system in accordance with the present invention; and

FIG. 2 is a flow chart showing a non-limiting implementation of the present logic.

### DETAILED DESCRIPTION OF THE PREFERRED EMBODIMENT

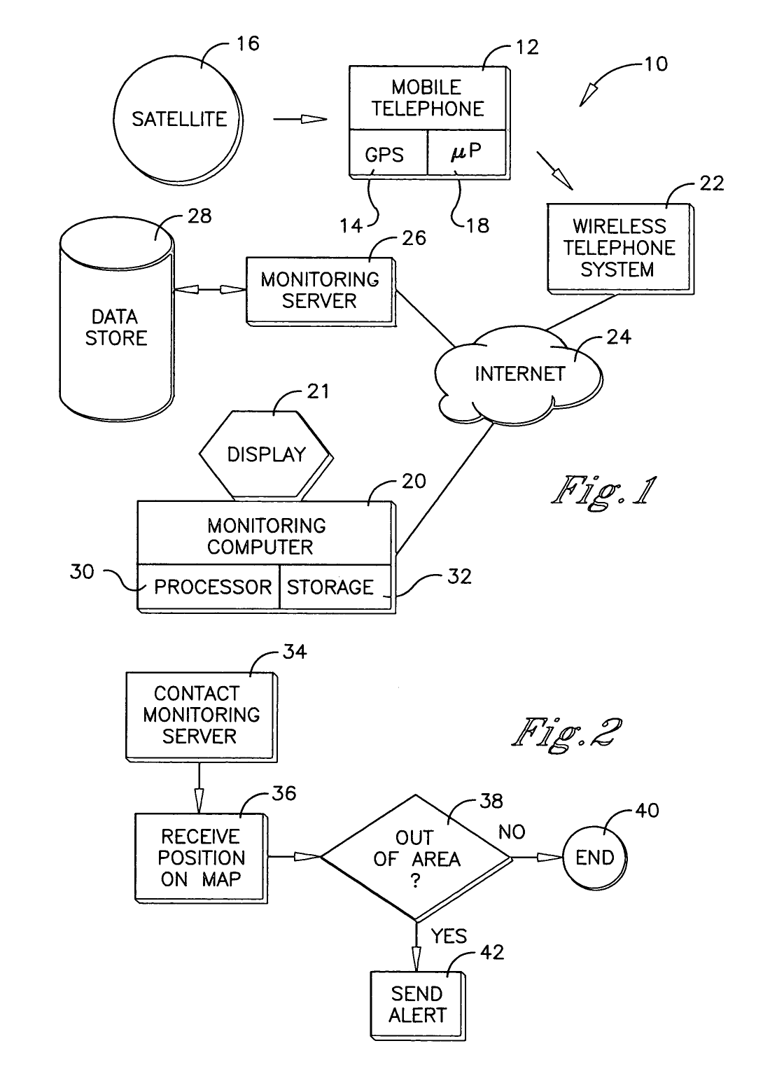

Referring initially to FIG. 1, a system is shown, generally designated 10, which includes at least one wireless communication device such as a wireless or mobile telephone 12 that has a position receiver 14 for receiving position information. In non-limiting implementations position information is received from one or more satellites 16, and thus is established by global position satellite (GPS) information that is representative of the location of the mobile telephone 12 on the Earth. The mobile telephone 12 can operate in accordance with any appropriate wireless communication principle, including, without limitation, CDMA, GSM, OFDM, etc. The mobile telephone 12 may be a data-only telephone such as, e.g., a personal digital assistant (PDA).

The mobile telephone 12 can include a processor 18 that operates in accordance with disclosure below to automatically and, e.g., periodically send the location of the mobile telephone 12 (and, hence, the location of a monitored object such as a child that is associated with the telephone 12) to a monitoring computer 20 with video display 21, which may belong to the parent of the child, for example. In other embodiments the video display 21 may be replaced by an audio display and position information audibly transmitted over the audio display using, e.g., voice recognition principles. The monitoring computer may be a personal computer with Web browser, laptop computer, PDA, or wireless telephone.

In the non-limiting implementation shown, the mobile telephone 12 automatically and periodically sends its latitude and longitude as represented by the GPS information through a wireless telephony system 22. The GPS information may be sent by, e.g., transmitting the latitude and longitude of the mobile telephone 12 using short message service (SMS). The period between position transmissions may be established by the user of the monitoring computer 20 by appropriately programming the processor 18 of the mobile telephone 12.

The wireless telephony system 22 may communicate directly with the monitoring computer 20 using, e.g., a telephone number of the monitoring computer 20, but in the non-limiting implementation shown the telephony system 22 relays the location of the mobile telephone 12 to the Internet 24. In some implementations, the GPS information is sent through the Internet 24 directly to the monitoring computer 20, while in other implementations the information is sent to a Web-based monitoring server 26 that can be accessed by the monitoring computer 20. The monitoring server 26 may access its own data store 28 as shown, while the processor 30 of the monitoring computer 20 may access a local data storage 32 such as a disk-based store, solid state memory, etc. Relevant logic of the invention may be stored in one or both of the data store 28 and local storage 32 for execution by the appropriate processor, as can be the GPS information and below-discussed maps.

With the overall exemplary non-limiting system 10 in mind, attention is now directed to FIG. 2, wherein at block 34 the monitoring computer 20 establishes contact with an entity, e.g., the monitoring server 26, supplying the position of the mobile telephone 12. Moving to block 36, the location of the mobile telephone 12 is presented on the display 21, preferably superimposed on a map that can be received from the data store 28 of the monitoring server 26 or that can be stored in the local storage 32 of the monitoring computer 20. In this way, the user of the monitoring computer 20 can view the location of the mobile telephone 12 and, hence, the monitored object on a map. Or, the position information may be displayed alpha-numerically, and may be a street address or latitude and longitude.

In some implementations, regardless of whether the user is actively viewing the map on the display 21, the logic may move to decision diamond 38 to determine whether the monitored object is out of an approved area. This test may be undertaken by first allowing a user of the monitoring computer 20 to define excluded areas on the map by inputting the latitude and longitude of boundary points of the area or by using, e.g., computer draw principles known in the art to draw the boundaries of the excluded area. Also, the user may define approved areas on the map. Yet again, an approved area may be established based on historical movement of the mobile telephone 12 as observed from the GPS locations, e.g., the locations of the mobile telephone 12 over the course of a predetermined time period such as a day or a week may define the boundaries of the approved area. Excluded areas may be presented on the map on the display 21 in one color, e.g., red, while approved areas may be presented on the map in another color, e.g., green.

In any case, if the mobile telephone 12 is not out of an approved area, the logic ends at state 40, but otherwise an alert can be generated at block 42. The alert may be generated any time the location of the mobile telephone 12 is outside of an approved area. Or, the alert may be generated only if the mobile telephone 12 strays into an excluded area. The alert may be presented in audible or visual form on the display 21, and/or the alert may be sent to the monitoring person out of band by, for instance, sending a SMS message to a wireless telephone whose telephone number the monitoring person has provided to the monitoring server 26.

It may now be appreciated that a monitor can access the position of a monitored object such as a child from a location that is remote from the child.

While the particular SYSTEM AND METHOD FOR MONITORING LOCATION OF OBJECT SUCH AS CHILD as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A system, comprising:
a mobile communication device configured to receive position information representative of the location of the device, the device configured to communicate the position information to a wireless telephony system; and
a monitoring computer receiving the position information and displaying the position information on a display.

2. The system of claim 1, wherein the mobile communication device is a wireless voice telephone or wireless personal digital assistant.

3. The system of claim 1, further comprising a monitoring server receiving the position information and communicating the information over the Internet to the monitoring computer.

4. The system of claim 1, further comprising a data store containing electronic map information, the monitoring computer receiving map information from the data store and presenting on the display a map in accordance with the map information, with the location of the mobile communication device indicated on the map.

5. The system of claim 1, further comprising a data store containing at least one of: approved areas, or excluded areas, the monitoring computer configured to receive an alert when the position information indicates that the location of the mobile communication device is outside the approved areas or inside the excluded areas.

6. The system of claim 1, wherein the position information is sent from the mobile communication device using short message service (SMS).

7. The system of claim 5, wherein the alert is sent to a wireless telephone using short message service (SMS).

8. A computer medium storing a program of instructions executable by a computer processor to:
receive a GPS location of a designated wireless communication device, the wireless communication device being associated with a monitored object; and
plot the GPS location on a map.

9. The computer medium of claim 8, wherein the map displays approved areas indicating areas in which presence of the monitored object is approved.

10. The computer medium of claim 8, wherein the map displays excluded areas indicating areas in which presence of the monitored object is not approved.

11. The computer medium of claim 9, wherein the approved areas are established using patterns of movement of the monitored object, the patterns being derived from observed GPS locations of the monitored object over time.

12. The computer medium of claim 8, wherein the wireless communication device is a wireless telephone.

13. The computer medium of claim 12, wherein the GPS location is received from the wireless telephone using SMS.

14. The computer medium of claim 12, wherein the GPS location is sent from the wireless telephone to a Web server accessible to the processor over the Internet.

15. The computer medium of claim 9, wherein an alert is received when the location of the monitored object is not in an approved area.

16. The computer medium of claim 10, wherein an alert is received only when the location of the monitored object is in an excluded area.

17. A method for monitoring the location of a person, comprising:
at a wireless telephone carried by the person, receiving position information;
sending the position information from the wireless telephone to a Web server;
allowing a monitor to access the Web server over the Internet using a monitoring computer; and
presenting, on a display associated with the monitoring computer, the location of the person as represented by the position information.

18. The method of claim 17, comprising sending an alert to a user of the monitoring computer when the location of the person as indicated by the position information is not in an approved area.

19. The method of claim 17, comprising sending an alert to a user of the monitoring computer only when the location of the person as indicated by the position information is in an excluded area.

20. The method of claim 18, wherein the approved area is established using patterns of movement of the person, the patterns being derived from observed GPS locations of the person over time.
